(19) United States
(12) Patent Application Publication
(10) Pub. No.: US 2015/0122594 A1
(43) Pub. Date: May 7, 2015

(54) BRAKE ACTUATOR FOR AIRCRAFT WHEEL HYDRAULIC BRAKE

(71) Applicant: MESSIER-BUGATTI-DOWTY, VELIZY VILLACOUBLAY (FR)

(72) Inventors: Robin LUCIENNE, VELIZY-VILLACOUBLAY (FR); Christophe VERDURMEN, VELIZY-VILLACOUBLAY (FR)

(73) Assignee: MESSIER-BUGATTI-DOWTY, VELIZY VILLACOUBLAY (FR)

(21) Appl. No.: 14/528,221

(22) Filed: Oct. 30, 2014

(30) Foreign Application Priority Data
Nov. 4, 2013 (FR) 13 60799

(51) Int. Cl. B64C 25/44; F16D 65/14; F16D 55/40; F16D 65/38

(52) U.S. Cl. CPC B64C 25/44; F16D 65/38; F16D 65/14; F16D 55/40; F16D 2121/04
USPC 188/71.8

(57) ABSTRACT

A brake actuator for an aircraft hydraulic brake, insertable in a cavity of a brake ring. The actuator comprises a liner (1) designed to be housed sealingly in the cavity of the ring, a piston (3) mounted to slide sealingly in the liner along an axis of sliding (X) so as to apply a braking force when a fluid is introduced under pressure into the cavity, and a wear compensation device (10) which defines a position to which the piston retreats into the liner by means of mobile stop (11) that can be moved forward by the piston as a braking force is applied. An elastic return member (16) returns the piston towards the position of retreat bearing against the mobile stop. The wear compensation device extends between the liner and the piston, downstream of a seal extending between the liner and the piston so as not to be bathed in the fluid in the cavity, the stop being held still by friction on the liner.

The invention relates to a brake actuator for an aircraft wheel hydraulic brake.

### TECHNICAL BACKGROUND OF THE INVENTION

The hydraulic brakes used for braking the wheels of aircraft generally comprise a ring having multiple cavities in which brake actuators are housed removably. Each of the actuators comprises a liner which is sealingly added to one of the cavities of the ring and in which a piston is mounted to slide sealingly along an axis of sliding. The ring distributes hydraulic fluid under pressure to all its cavities, which fluid acts on the piston in order to cause it to deploy and apply a braking force to friction pads extending opposite the ring, rotors of which rotate with the wheels and stators of which are prevented from rotating.

In general, the piston has an operational travel that it covers when a braking force is applied. This operational travel, of the order of a few millimetres, is enough to allow the braking force to be applied to the friction pads and to cause the push-rod to retreat to allow the rotors to rotate freely. To this end, a spring extending inside the piston ensures that the push-rod retreats into a position of retreat when the braking force is no longer applied.

However, the friction pads gradually become worn as a result of repeated application of braking forces so it is important to ensure that the piston is always near the friction pads. In order to achieve this it is known practice to fit the brake actuators with a wear compensation device that extends inside the piston. The wear compensation device comprises a mobile stop which is mounted to slide with friction along the axis of sliding on a central rod extending into the piston and which defines the position to which the piston retreats.

When a braking force is applied, the piston is pushed towards the friction pads and, if necessary, carries the mobile stop along with it, overcoming the friction between the rod and the stop, thereby causing the mobile stop to move forward along the central rod. When the force is released, the spring, which extends between the mobile stop and the piston, causes the piston to retreat as far as the new position of retreat, which has moved forward because the mobile stop has moved forward.

There are essentially two technologies for this type of brake actuator. In one of them, known as wet piston technology, the hydraulic fluid is admitted into the piston and bathes the wear compensation system. These actuators are simple but have the disadvantage that the fluid extends into regions near the end of the piston which is subjected to high temperatures because of the frictional heating caused by the friction pads of the brake. The result of this is impaired physicochemical properties of the hydraulic fluid, which may ultimately impair braking performance.

In the other of the technologies, referred to as dry piston technology, a seal is interposed between the piston and the central rod so that the fluid remains confined behind the piston and no longer bathes the wearing device. However, such a technology entails the use of an additional seal, which presents other problems of wear in use.

### OBJECT OF THE INVENTION

It is an object of the invention to propose a brake actuator for an aircraft hydraulic brake that does not have the aforementioned disadvantages.

### PRESENTATION OF THE INVENTION

In order to achieve this goal, there is proposed a brake actuator for an aircraft hydraulic brake, which is intended to be added into one of the cavities of a brake ring, the actuator comprising

a liner designed to be housed sealingly in the cavity of the ring;

a piston mounted to slide sealingly in the liner along an axis of sliding so as to apply a braking force when a fluid is introduced under pressure into the cavity;

a wear compensation device which defines a position to which the piston retreats into the liner by means of a mobile stop that can be moved forward by the piston as a braking force is applied;

an elastic return member returning the piston towards the position of retreat bearing against the mobile stop;

in which, according to the invention, the wear compensation device extends between the liner and the piston, the stop being held still by friction on the liner.

The actuator of the invention does not comprise a central rod. It is therefore possible to close off the proximal part of the piston completely so as to prevent the fluid from extending near the distil part of the piston, while at the same time avoiding the use of a seal. The assembly is therefore mechanically far simpler and avoids the use of an additional seal.

### BRIEF DESCRIPTION OF THE DRAWINGS

The invention will be better understood in the light of the following description given with reference to the figures of the attached drawings, among which :

FIG. 1 is a view in section of a brake actuator according to the invention, illustrated in place in a ring of an aircraft hydraulic brake;

FIG. 2 is a figure similar to FIG. 1, the actuator being illustrated as a braking force is being applied;

FIG. 3 is a figure similar to FIG. 2, the actuator being illustrated after the braking force has been released.

### DETAILED DESCRIPTION OF THE INVENTION

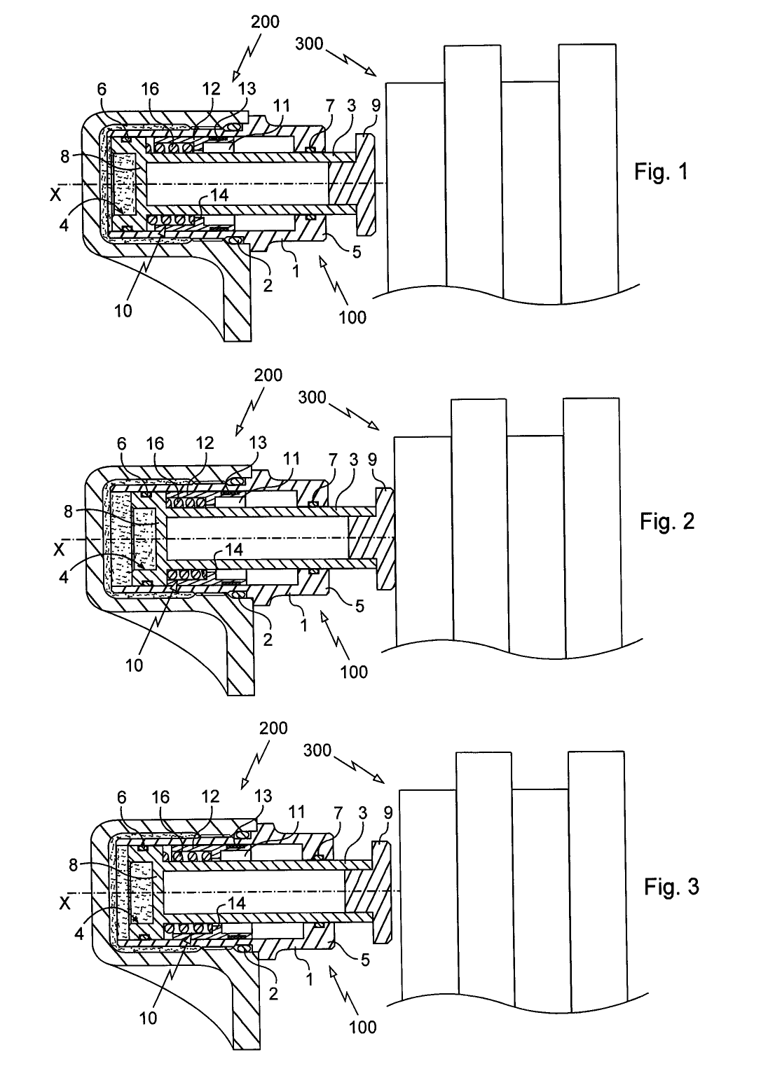

With reference to FIG. 1, the brake actuator 100 of the invention is intended to be housed in one of the cavities 200 of a ring of an aircraft hydraulic brake, which moreover comprises friction pads 300 comprising a succession of rotor discs and stator discs, for example discs made of carbon, on which the actuator selectively applies a braking force when pressurized fluid (illustrated as dots) is admitted to the cavity 200.

The actuator 100 first of all comprises a generally cylindrical liner 1 which is housed sealingly inside the cavity 200 of the ring. For that purpose, a seal 2 collaborates with an external face of the liner to contain the hydraulic fluid within the cavity.

A piston 3 is mounted to slide in the liner 1 along an axis of sliding X. To that end, the proximal end 4 of piston 3 is shaped like a bearing which fits closely against an internal face of the liner 1. The distal end 5 of the liner 1 is shaped as a bearing to guide the piston 3. The proximal end 4 of the piston 1 is fitted with a seal 6 while the distal end 5 of the liner 1 is fitted with a scraper 7.

It will be noted that the proximal end 4 of the piston 3 is in this instance closed by a wall 8 formed as an integral part of the piston, so as to confine the hydraulic fluid in a zone distant from the discs 300. The distal end of the piston 3 accommodates a shoe 9 to apply pressure to the discs 300.

The actuator 100 is provided with a wear compensation device 10, which, according to the invention, extends between the liner 1 and the piston 3. The wear compensation device 10 comprises a mobile stop 11 which comprises a skirt 12 fitting closely against the internal face of the liner 1. The skirt 12 comprises a recess to house a friction ring 13 bearing against the internal face of the liner 1 to allow the mobile stop 11 to be immobilized through the effect of friction relative to the liner 1. The skirt 12 extends towards the proximal end 4 of the piston 3 to allow the piston 1 to come to bear against the skirt 12 and therefore carry with it the mobile stop 11 against the action of the friction generated by the friction ring 13 when a braking force is applied. The mobile stop 11 moreover comprises a wall 14 extending radially from the skirt 12 to act as a support for a spring 16 that extends between the said wall 14 and the proximal end 4 of the piston 3 along the skirt 12 inside the latter in order to return the piston 3 towards a position of retreat, reached when the spring is released and ends up pushing the piston 3 back. It will be noted that the wear compensation device is not bathed in the hydraulic fluid because it extends downstream of the seal 6. Moreover, it is protected from external contamination by the scraper 7.

The way in which the brake actuator of the invention works is as follows. Starting from the position of retreat illustrated in FIG. 1, a braking force is applied by admitting the pressurized fluid to the cavity 200. The fluid pushes the piston 3 towards the discs 300. If, before coming into contact with the discs 300, the piston butts against the skirt 12 of the mobile stop 11, that stop is moved forward in the liner 1 by the piston 3 against the effect of the friction generated by the friction ring 13, until the piston 3 comes into contact with the discs 300 as illustrated in FIG. 2.

Then, when the braking force is released, the piston returns under the effect of the spring 16 until the spring 16 is fully relaxed and can no longer push the piston 3 back, thus defining a new position of retreat, further forward in relation to the previous one, as illustrated in FIG. 3. The operational travel of the piston (between the position of FIG. 2 and the position of FIG. 3) is unchanged, only the position of retreat has moved forward slightly in order to compensate for the wearing of the discs 300.

It will be noted that the interface between the liner and the cavity of the ring is absolutely unchanged by the arrangements of the invention. It is therefore possible to organize a replacement of brake actuators already in use with brake actuators according to the invention which have exactly the same external interfaces.

The invention is not restricted to that which has just been described but on the contrary encompasses any variant that falls within the scope defined by the claims.

1. Brake actuator for an aircraft hydraulic brake, which is intended to be added into one of the cavities of a brake ring, the actuator comprising
a liner (1) designed to be housed sealingly in the cavity of the ring;
a piston (3) mounted to slide sealingly in the liner along an axis of sliding (X) so as to apply a braking force when a fluid is introduced under pressure into the cavity;
a wear compensation device (10) which defines a position to which the piston retreats into the liner by means of mobile stop (11) that can be moved forward by the piston as a braking force is applied;
an elastic return member (16) returning the piston towards the position of retreat bearing against the mobile stop;
characterized in that the wear compensation device extends between the liner and the piston, downstream of a seal extending between the liner and the piston so as not to be bathed in the fluid in the cavity, the stop being held still by friction on the liner.

2. Brake actuator according to claim 1, in which the mobile stop comprises a skirt (12) which extends against an internal face of the liner and which has an end that extends in such a way as to be pushed back by the piston as a braking force is applied.

3. Actuator according to claim 2, in which the skirt (12) comprises a housing to accommodate a friction member (13) which collaborates with the internal face of the liner to immobilize the stop relative to the liner.

4. Brake actuator according to claim 2, in which the elastic member is a helical spring (16) extending inside and along the skirt.

5. Brake actuator according to claim 1, in which the piston has a proximal end (4) that is closed and fluidtight.

6. Brake actuator according to claim 1, in which the liner has a distal end (5) which defines a bearing that guides the piston and which bears a scraper (7).
